(19) United States
(12) Patent Application Publication
(10) Pub. No.: US 2015/0345682 A1
(43) Pub. Date: Dec. 3, 2015

(54) RELEASABLE CONDUIT CONNECTION DEVICE AND PIPELINE PROVIDED WITH SUCH A DEVICE

(71) Applicant: AIRBUS OPERATIONS (S.A.S.), Toulouse Cedex (FR)

(72) Inventors: Damien Fraysse, Toulouse (FR); Christophe Casse, Fenouillet (FR)

(21) Appl. No.: 14/640,894

(22) Filed: Mar. 6, 2015

(30) Foreign Application Priority Data
Jun. 3, 2014 (FR) 14 51830

(51) Int. Cl. F16L 37/086; F16L 21/08

(52) U.S. Cl. CPC F16L 37/086; F16L 21/08; F16L 2201/40

(57) ABSTRACT

A connection device for a releasable conduit including an end piece of a first conduit, a ring nut capable of being joined while in use to a locking ring of the releasable conduit, the ring nut being integral with the end piece. According to the disclosure herein, an auxiliary element is movably mounted on the end piece between a retracted position (PR) and an extended position (PS), so as to alter the axial length of the first conduit. The disclosure herein likewise relates to a pipeline for the circulation of a fluid, in particular fuel, including a connection device of this kind.

### CROSS-REFERENCE TO RELATED APPLICATION

This application claims the benefit of and priority to French patent No. 1451830, filed Mar. 6, 2014, the entire disclosure of which is incorporated by reference herein.

### TECHNICAL FIELD

The disclosure herein relates to the field of conduit connections in a pipeline, in particular for carrying fuel in an aircraft. More particularly, an object of the disclosure herein is a releasable conduit connection device and a pipeline provided with such a device.

### BACKGROUND

An aircraft traditionally comprises a plurality of pipelines, each of which comprises a plurality of interconnected conduits. In order to gain access to the various pieces of aircraft equipment, in particular during maintenance operations, it is sometimes necessary to disconnect a conduit from the pipeline in order to remove it temporarily and thereby free up space within which technicians can move.

FIG. 1 shows an axial pipeline 100 comprising a first conduit 101, a releasable conduit 102 and a second conduit 103 for carrying fuel. The releasable conduit 102 comprises a first end 102A connected to the first conduit 101 by first connection 140 and a second end 102B connected to the second conduit 103 by second connection 150.

Traditionally, the first connection 140 comprises a locking ring 141 movably mounted on the releasable conduit 102 and a ring nut 142 joined to the first fixed conduit 101 as illustrated in FIG. 1. Similarly, the two connections 150 comprise a locking ring 151 movably mounted on the releasable conduit 102 and a ring nut 152 joined to the second conduit 103. In practice, each locking ring 141, 151 is fixed to its ring nut 142, 152 by bolts.

In order to remove the releasable conduit 102, a technician must perform the following steps:

disconnect the first locking ring 141 from the first ring nut 142 of the first conduit 101;

move the first locking ring 141 towards the center of the releasable conduit 102, in order to disengage the first end 102A of the releasable conduit 102; disconnect the second locking ring 151 from the second ring nut 152 of the second conduit 103;

move the second locking ring 151 towards the center of the releasable conduit 102, in order to disengage the second end 102B of the releasable conduit 102; and

remove the releasable conduit 102, the ends 102A, 102B of which are disengaged.

A significant number of operations is required in order to remove and/or replace the releasable conduit 102, which prolongs the maintenance time. As removal/replacement operations for a releasable conduit 102 are carried out frequently throughout the life of an aircraft, this kind of pipeline generates a significant maintenance cost.

There is therefore a need to improve the connection of the conduits in an aircraft pipeline system, while at the same time maintaining optimum assembly between the conduits and avoiding any leaks, any assembly clearance and any assembly defects.

### SUMMARY

To this end, a first object of the disclosure herein relates to a connection device for a releasable conduit comprising an end piece of a first conduit, a ring nut capable of being joined while in use to a locking ring of the releasable conduit, the ring nut being integral with the end piece, wherein an auxiliary element is movably mounted on the end piece between a retracted position (PR) and an extended position (PS), so as to alter the axial length of the first conduit.

The auxiliary element preferably comprises a ring mounted in axial translation on the end piece by at least one guide pin. Hence, the translation of the auxiliary element allows an axial assembly clearance to be created easily when it is moved from the retracted position towards the extended position.

According to a preferred aspect of the disclosure herein, the auxiliary element is mounted externally on the end piece to allow for easy handling and maintenance.

The auxiliary element preferably comprises locking structure of the element in the extended position and the locking structure is adapted to deform in the retracted position. In other words, the locking structure performs a locking function on the one hand and a signaling function on the other. Hence, the retracted position can be identified quickly and easily by a technician, which prevents any assembly defect in the pipeline.

According to one embodiment, the locking structure comprises at least one longitudinal tongue comprising a locking pin adapted to cooperate with a hole formed in the outer surface of the end piece. The tongue is preferably formed in the body of the ring by making a pair of recesses.

One end of the tongue is advantageously integrated in the body of the ring and two cuttings are made at this end on both sides of the tongue.

A second object of the disclosure herein relates to a pipeline for the circulation of a fluid, in particular fuel, successively comprising a first conduit, a releasable conduit comprising a movable locking ring and a second conduit, wherein the releasable conduit is connected, on the one hand, to the first conduit by the fixing of the locking ring to a connection device according to the first object of the disclosure herein and, on the other hand, to the second conduit by the second connection.

The pipeline is remarkable in that the first conduit comprises at least a main body and an auxiliary element movably mounted on the main body between an extended position configured to lock the releasable conduit and a retracted position configured to create an assembly clearance, in order to allow the releasable conduit to be removed.

Thanks to the disclosure herein, the length of the first conduit can be altered by moving the auxiliary element in order, on the one hand, to lock the movable conduit and avoid any assembly defect when the liquid circulates in the pipeline and, on the other hand, to create an assembly clearance, in order to allow the releasable conduit to be removed away from the pipeline. Hence, work can be carried out on the first conduit to allow the releasable conduit to be removed, which saves time. Moreover, as an assembly clearance is created by the first conduit, the second connection can be simplified, thereby reducing the mass and cost of the same.

According to one aspect of the disclosure herein, the second connection is interlocking so as to allow a quick, easy connection of the releasable pipeline to the second conduit. In other words, the second connection does not have any bolt to release, which saves time.

The second conduit preferably extends axially and comprises an axial housing adapted to receive one end of the releasable pipeline. The second connection is formed by the releasable conduit and the housing of the second conduit which cooperate by interlocking.

The disclosure herein further relates to an aircraft comprising at least one pipeline such as that introduced previously.

An object of the disclosure herein is likewise a removal procedure for a releasable conduit from a pipeline for the circulation of fluid, in particular fuel, the pipeline successively comprising a first conduit, a releasable conduit and a second conduit, the releasable conduit being connected, on the one hand, to the first conduit by the first connection and, on the other hand, to the second conduit by the second connection, the procedure comprising:

a modification stage of the length of the first conduit, so as to create an assembly clearance;

a movement stage of the releasable conduit in the direction of the first conduit; and

a removal stage of the releasable conduit.

Thanks to the procedure according to the disclosure herein, a technician can remove a releasable conduit quickly and easily by creating an assembly clearance. This kind of procedure is easy to implement and saves time, given that there is no need to work on the connection.

### BRIEF DESCRIPTION OF THE DRAWINGS

The disclosure herein will be more clearly understood by reading the following description, provided solely by way of example, and referring to the attached drawings in which:

FIG. 1 is a sectional view of a pipeline according to the prior art (already referred to);

FIG. 2 is a sectional view of a pipeline according to an embodiment of the disclosure herein;

FIG. 3 is a perspective representation of the link between the first conduit and the releasable conduit;

FIG. 4 is a perspective representation of the connection device;

FIGS. 5a-5c are a close-up representations of the link between the main body and the auxiliary element of the connection device according to the disclosure herein;

FIG. 6 is a perspective representation of a guide pin of the first conduit;

FIG. 7 is a perspective representation of the auxiliary element of the first conduit;

FIG. 8 is a close-up perspective representation of the tongue of the auxiliary element in the retracted position;

FIG. 9 is a perspective representation of the first conduit in the extended position;

FIG. 10 is a perspective representation of the first conduit in the retracted position;

FIG. 11 is a sectional view of the connection of the releasable conduit with the first conduit in the retracted position;

FIG. 12 represents the pipeline in the working position;

FIG. 13 represents the first conduit in the retracted position to allow axial translation of the releasable conduit; and

FIG. 14 represents the releasable conduit extended from the housing of the second conduit.

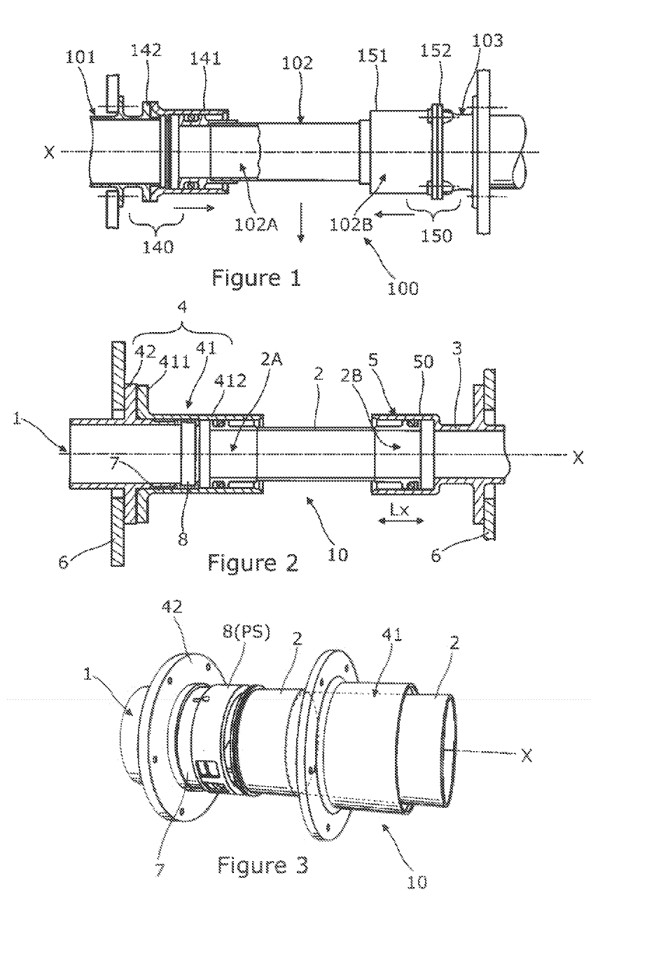

### DETAILED DESCRIPTION

It should be noted that the figures show the disclosure herein in detailed form to allow the disclosure herein to be implemented, while the figures may of course be used to better define the disclosure herein, as appropriate.

A pipeline according to the disclosure herein is going to be introduced for use in an aircraft. Needless to say, the disclosure herein can be used in other fields for the circulation of various kinds of fluid.

With reference to FIG. 2, a pipeline 10 is represented successively comprising a first conduit 1, a second conduit 2 and a third conduit 3. In this example, the first conduit 1, the second conduit 2 and the third conduit 3 extend coaxially according to an axis X.

In the following, the terms “inner” and “outer” are defined radially relative to the axis X of the pipeline, such that an axial conduit comprises an inner surface turned towards the axis and an outer surface opposite the inner surface.

In this example, the first conduit 1 and the third conduit 3 are fixed conduits; the second conduit 2 is a releasable conduit capable of being removed from the pipeline 10. The first conduit 1 and the third conduit 3 are joined to a fixed housing 6. The conduits 1, 2, 3 are tubular conduits with an annular section extending axially along an axis X.

As illustrated in FIG. 2, the second conduit 2 comprises a first end 2A connected to the first conduit 1 by first connection 4 and a second end 2B connected to the third conduit 3 by second connection 5. Each end 2A, 2B of the second conduit 2 preferably comprises a gasket (not indicated).

In this exemplary embodiment, the first connection 4 comprises a connection device according to an embodiment of the disclosure herein and a locking ring 41 movably mounted in axial translation on the second conduit 2 and locked to the connection device, preferably by bolts.

The connection device comprises an end piece (or main body) 7 of the first conduit 1, a ring nut 42 integral with the end piece 7 and an auxiliary element (or stop) 8 movably mounted on the main body 7 between a retracted position PR (FIG. 10) and an extended position PS (FIG. 9), so as to alter the axial length of the first conduit 1. In one embodiment, the end piece 7 is integrated in the first conduit 1. In another embodiment, the end piece 7 is integrated in the connection device.

The end piece 7 may comprise holes (not indicated), in order to reduce the total mass of the assembly.

As illustrated in FIG. 2, the ring nut 42 extends radially to the axis of the pipeline 10 and is adapted for bolting with the locking ring 41 which comprises a radial nut 411 integral with a longitudinal casing 412. The locking ring 41 advantageously extends externally to the first conduit 1, to the end piece 7, to the auxiliary element 8 and to the second conduit 2, so as to enclose their abutment zone and thereby avoid any disengagement of the first end 2A of the second conduit 2.

The second connection 5 in this example is integrated in the third conduit 3 at its connection end with the second conduit 2. Hence, with reference to FIG. 2, the connection end of the third conduit 3 is in the form of a longitudinal cylindrical housing 50 adapted to receive by interlocking the second end 2B of the second conduit 2, in order to align it with the third conduit 3. Consequently, the axial length of the housing 50 is labeled Lx in FIG. 2. Also, in order to disengage the second conduit 2, it is necessary to move the second conduit 2 axially towards the first conduit 1 by an axial distance greater than the length Lx, in order to remove the second extremity 2B from the housing 50, as will be explained in detail below.

FIG. 3 depicts in schematic form the pipeline 10 after the locking ring 41 has been displaced, in order to gain access to the abutment zone between the first conduit 1 and the second conduit 2. Still indicated in FIG. 3, the auxiliary element 8 is in the extended position PS relative to the main body 7, so as to produce a significant axial length and prevent the creation of an axial assembly clearance allowing the second conduit 2 to be removed.

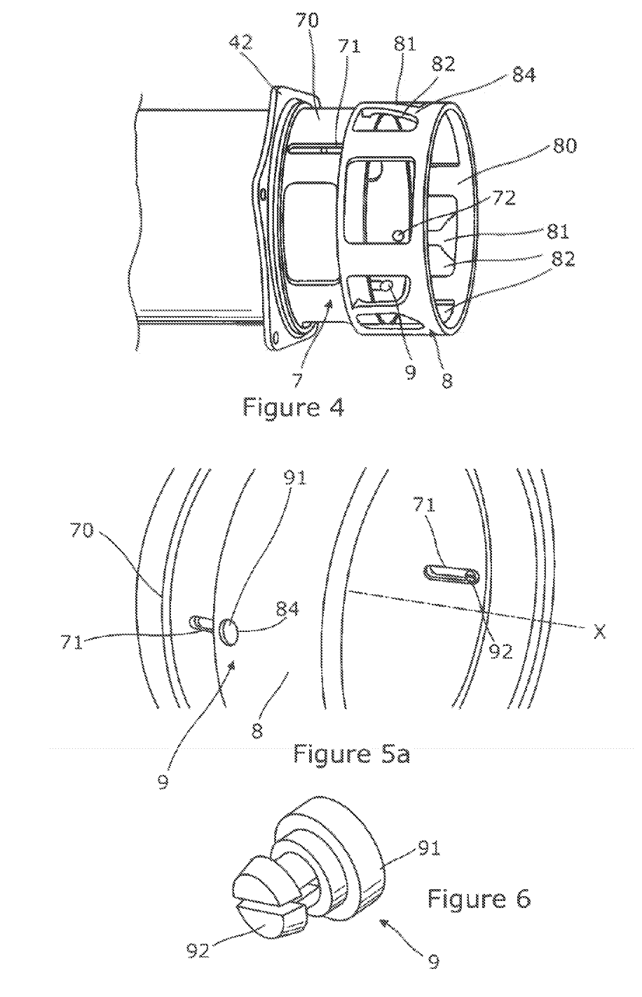

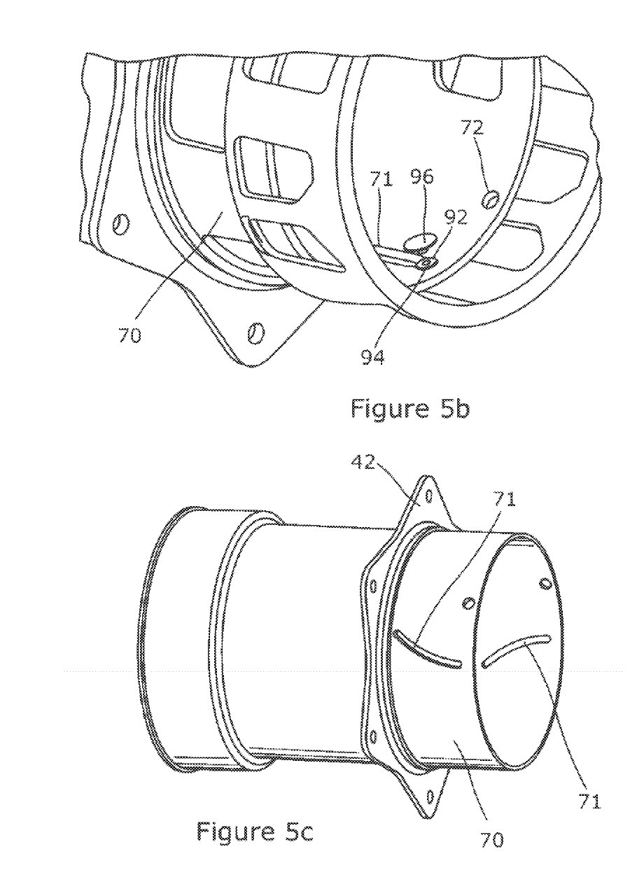

With reference to FIG. 4, the ring nut 42 of the connection device adapted to cooperate with the locking ring 41 is formed on the main body 7. The main body 7 further comprises a cylindrical pipe 70 on which the auxiliary element 8 is movably mounted. In this example, the auxiliary element 8 comprises a ring 80 mounted in axial translation on the cylindrical pipe 70 of the main body 7. To this end, the cylindrical pipe 70 comprises two longitudinal slots 71 in each of which guide pins 9 integral with the auxiliary element 8 are mounted, as illustrated in FIGS. 4, 5a and 5b. In an embodiment illustrated in FIG. 5c, the longitudinal slots 71 are shaped as circular arcs with the same radius disposed opposite one another. Hence, the connection device allows a translational and rotational movement of the auxiliary element 8, which allows the pipelines to be assembled and dismantled.

Each guide pin 9 extends radially relative to the axis X of the pipeline 10. With reference to FIG. 6, each guide pin 9 comprises at one end a base 91 designed to be mounted integrally with the auxiliary element 8 and, at its other end, a head 92 designed to extend into the longitudinal slot 71 of the main body 7. As illustrated in FIG. 5, the head 92 is preferably split so as to allow the guide pin 9 to be assembled radially towards the axis X successively crossing a mounting hole 84 in the ring 80 and the longitudinal slot 71, such that the head 92 extends internally to the auxiliary element 8. Advantageously, the guide pin 9 can no longer be removed following its assembly. For example, as illustrated in FIG. 5b, the head 92 comprises a housing 94 in which a crimp 96 is inserted. Hence, it is no longer possible to dissociate the auxiliary element 8 from the main body 7, which prevents any assembly defect.

Hence, thanks to the axial translation, the auxiliary element 8 can be moved on the main element 7 between an extended position PS (FIG. 9) and a retracted position PR (FIG. 10), for which the axial length of the first conduit 1 is reduced relative to the extended position PS by an axial assembly clearance ΔX. In other words, the movement of the auxiliary element 8 in relation to the main body 7 allows an axial assembly clearance ΔX to be formed.

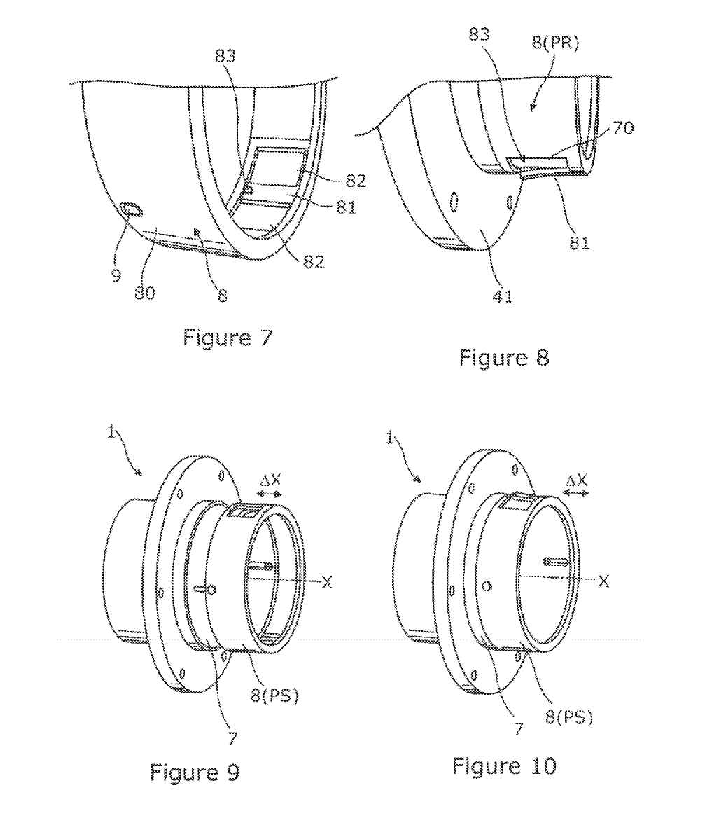

With reference to FIGS. 4 and 7, in order to lock the auxiliary element 8 in the extended position PS, the auxiliary element 8 comprises locking structure adapted to lock the auxiliary element 8 in relation to the main body 7. In this example, the locking structure takes the form of two longitudinal tongues 81, each comprising a locking pin 83 formed on an inner face of the tongue 81 adapted to cooperate with a hole 72 formed in the outer surface of the pipe 70. Hence, the locking pin 83 withstands the axial loads and enables any axial translation of the auxiliary element 8 to be prevented.

Each tongue 81 is advantageously formed in the body of the ring 80, so as to limit its overall size. With reference to FIGS. 4 and 7, the ring 80 comprises two recesses 82 formed on either side of each tongue 81 and two cuttings 84 made on either side of the base of the tongue 81 to allow a technician to manipulate the tongue 81, in order to remove the locking pin 83 from the hole 72 in the pipe 70 in the extended position PS.

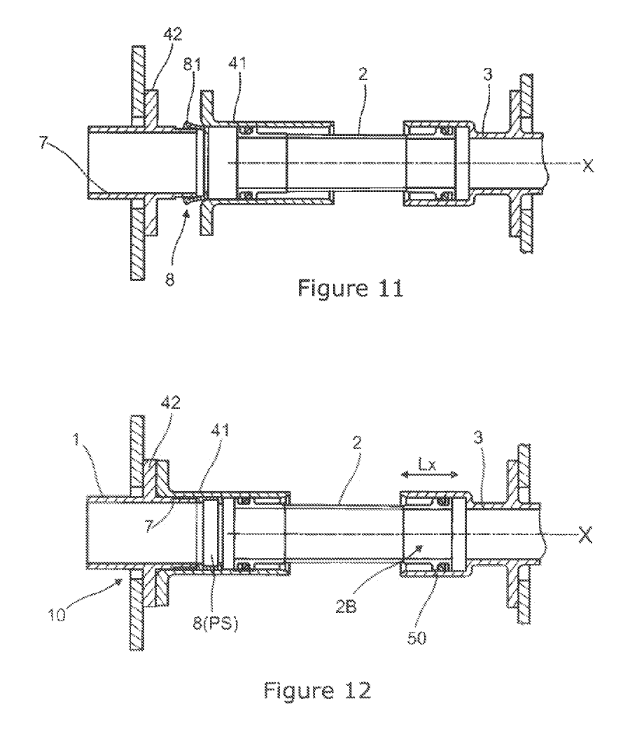

With reference to FIG. 8, when the auxiliary element 8 is in the retracted position PR, the locking pin 83 is supported on the outer surface of the pipe 70, which elastically deforms the tongue 81 which no longer extends longitudinally. On the one hand, this allows the technician to receive a visual warning that the auxiliary element 8 is in the retracted position PR and, on the other hand, to prevent a connection of the second conduit 2 to the first conduit 1 in the retracted position PR. In fact, as illustrated in FIG. 11, when the auxiliary element 8 is in the retracted position PR the tongue 81 is deformed, which increases the radial dimension of the first conduit 1 and thereby prevents movement of the locking ring 41 on the first conduit 1 as will be presented below.

An example of a removal procedure of the second conduit 2 according to the disclosure herein is now going to be presented with reference to FIGS. 12 to 14.

With reference to FIG. 12, when in use the second end 2B of the second conduit 2 is housed by interlocking in the casing 50 of the third conduit 3, which prevents any transverse movement and also any axial movement towards the third conduit 3.

The auxiliary element 8 is in the extended position PS relative to the main body 7, as illustrated in FIG. 12, the auxiliary element 8 abutting the second conduit 2. The first conduit 1 therefore has a significant axial length, preventing any axial movement of the second conduit 2 which remains locked in axial translation between the first conduit 1 and the third conduit 3.

In order to remove the second conduit 2, the locking ring 41 is disconnected from the connection device, in other words from the ring nut 42, then translated axially towards the third conduit 3, in order to access the auxiliary element 8 of the first conduit 1.

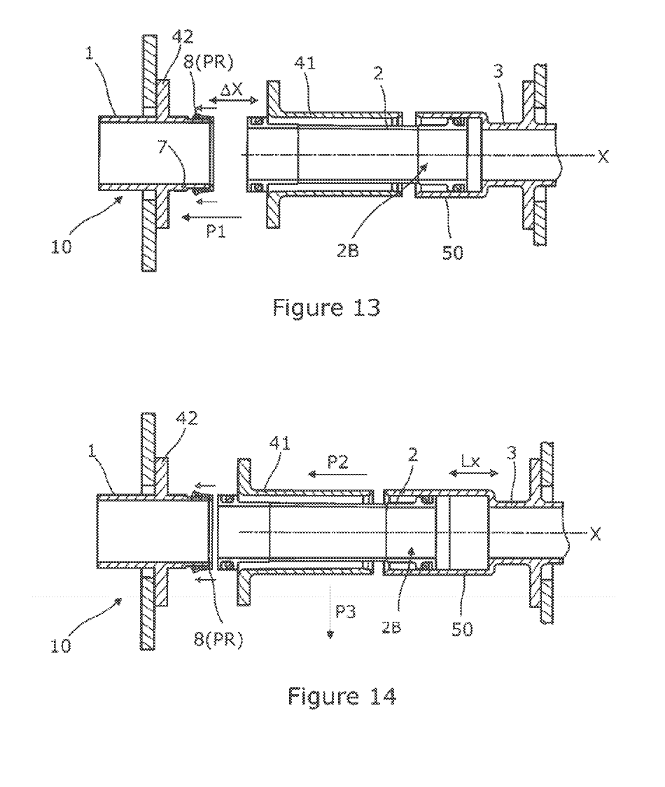

Next, as depicted in FIG. 13, the axial length of the first conduit 1 is altered (stage P1) by pulling on the tongues 81 in order to disengage the locking pins 83 (FIG. 7) then axially translating the auxiliary element 8 towards the main body 7, in order to reach the retracted position PR. Access to the tongues 81 is easy, given that the technician is able to slip his hand via the recesses 82 (FIG. 7) formed in the ring 80 of the auxiliary element 8. Following the displacement, an assembly clearance ΔX is created between the first conduit 1 and the second conduit 2, as illustrated in FIGS. 9, 10 and 13.

The axial assembly clearance ΔX is advantageously at least equal to the axial dimension Lx of the housing 50 in which the second conduit 2 is mounted. Hence, as illustrated in FIG. 14, the second conduit 2 can be advantageously translated axially towards the first conduit 1 (stage P2), in order to disengage its second end 2B from the housing 50. It is thereby possible to remove the second conduit 2 by displacing it transversely to the axis X of the pipeline 10 (stage P3).

Similarly, in order to replace the releasable pipeline 2 after the technicians have gone past, it is sufficient for the second conduit 2 to be replaced in the housing 50 of the third conduit 3 and then to replace the auxiliary organ 8 in the extended position PS relative to the main body 7, in order to cancel out any axial assembly clearance ΔX. Finally, all that is required is for the locking ring 41 to be fixed and thereby enclose the abutment zone between the first conduit 1 and the second conduit 2. As specified previously with reference to FIG. 11, any fixing of the locking ring 41 becomes impossible if the auxiliary element 8 is not in the extended position PS, the tongues 81 (FIG. 7) then performing a correcting function.

Thanks to the disclosure herein and particularly to the connection device, the removal of a second conduit 2 is easy to implement and requires a smaller number of stages, which allows the maintenance operations to be accelerated and therefore the cost of these to be reduced. Moreover, the quality of the assembly is improved, which guarantees optimum safety over time.

Needless to say, the cylindrical pipe 70 could only comprise a single slot or more than two longitudinal slots 71. The use of two slots 71 allows the complexity of the first conduit 1 to be limited while allowing optimum guiding.

It goes without saying that the auxiliary element 8 could only comprise a single longitudinal tongue 81. The use of two tongues 81 enables the complexity of the first conduit 1 to be limited while allowing optimum locking.

In the exemplary embodiment shown, the first conduit 1, the second conduit 2 and the third conduit 3 extend coaxially along an axis X, but it goes without saying that the disclosure herein can likewise be applied to a second bent conduit 2, the ends whereof extend along two axes parallel to one another.

Conduits with an annular section have been introduced but it goes without saying that their section could be oval, rectangular or another shape.

A ring 80 comprising two recesses 82 has been introduced but it goes without saying that the ring 80 could comprise only a single recess 82.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. A connection device for a releasable conduit, comprising:
an end piece of a first conduit;
a ring nut capable of being joined while in use to a locking ring of the releasable conduit, the ring nut being integral with the end piece;
the connection device comprising an auxiliary element movably mounted on the end piece between a retracted position and an extended position, so as to alter the axial length of the first conduit;
the auxiliary element comprising a ring mounted in axial translation on the end piece by at least two guide pins each mounted in a longitudinal slot situated on a cylindrical pipe of the end piece; and
the longitudinal slots being shaped as circular arcs with the same radius disposed opposite one another.

2. The device according to claim 1, wherein the auxiliary element comprises locking structure of the element in the extended position and wherein the locking structure is adapted to deform in the retracted position.

3. The device according to claim 2, wherein the locking structure comprises at least one longitudinal tongue comprising a locking pin adapted to cooperate with a hole formed in the outer surface of the end piece.

4. The device according to claim 3, wherein the tongue is formed in the body of the ring by a pair of recesses.

5. The device according to claim 4, wherein one end of the tongue is integrated in the body of the ring and wherein two cuttings are made at this end on both sides of the tongue.

6. A pipeline for circulation of a fluid, comprising a first conduit, a second conduit that is a releasable conduit, and comprising:
a movable locking ring;
a third conduit; and
wherein the releasable conduit is connected to the first conduit by fixing of the locking ring to a connection device according to claim 1, and, to the third conduit by a second connection.

7. The pipeline according to claim 6, wherein the second connection is interlocking.

8. The pipeline according to claim 6 in which the third conduit extends axially and comprises an axial housing adapted to receive one end of the releasable pipeline.

9. The pipeline according to claim 8, in which an axial length of the housing is smaller than an axial assembly clearance defined between the retracted position and the extended position of the first conduit.
